(19) United States
(12) Patent Application Publication
(10) Pub. No.: US 2026/0124966 A1
(43) Pub. Date: May 7, 2026

(54) SEAT ADJUSTMENT APPARATUS OF VEHICLE AND VEHICLE INCLUDING THE SAME

(71) Applicants: HYUNDAI MOTOR COMPANY, SEOUL (KR); KIA CORPORATION, SEOUL (KR)

(72) Inventors: Guang You Dong, Yantai (CN); Hongzhu Tang, Yantai (CN); Wen Da Li, Yantai (CN)

(73) Assignees: HYUNDAI MOTOR COMPANY, SEOUL (KR); KIA CORPORATION, SEOUL (KR)

(21) Appl. No.: 19/368,616

(22) Filed: Oct. 24, 2025

(30) Foreign Application Priority Data
Nov. 7, 2024 (CN) 202411580945.5

(51) Int. Cl. B60N 2/02; B60N 2/00

(52) U.S. Cl. CPC B60N 2/0256; B60N 2/0029; B60N 2/0273

(57) ABSTRACT

The present disclosure provides a seat adjustment apparatus of a vehicle and a vehicle including the same. The vehicle includes a first row of seats and a second row of seats positioned behind the first row of seats, the first row of seats includes a first seat and a second seat, and a passage for passenger traffic is provided between the first seat and the second seat, and the seat adjustment apparatus of the vehicle includes: a vehicle interior passenger sensor that detects a passenger on the first row of seats; and a vehicle exterior passenger sensor that detects a passenger outside the vehicle attempting to board the vehicle, in which, when it is determined that there is a passenger attempting to go to the second seat through a front of the first seat according to the detection results of the vehicle interior passenger sensor and the vehicle exterior passenger sensor, the first seat is configured to move backward.

### CROSS REFERENCE TO RELATED APPLICATIONS

This application claims priority to and the benefit of Chinese Patent Application No. 202411580945.5 filed with the Chinese National Intellectual Property Administration on Nov. 7, 2024, the entire contents of which are incorporated herein by reference.

### BACKGROUND

### (a) Field

The present disclosure relates to a seat adjustment apparatus of a vehicle and a vehicle including the same.

### (b) Description of the Related Art

FIG. 1 is a diagram illustrating an interior of a conventional commercial vehicle. The commercial vehicle includes three rows of seats. A first row of seats includes a driver's seat and a passenger's seat, a second row of seats includes two seats, each positioned behind the driver's seat and behind the passenger's seat, a third row of seats is positioned behind the second row of seats, and the third row of seats also includes two seats. A passage is provided between the two seats of the second row of seats, so that passengers may access the third row of seats through the passage, and also go from the third row of seats to the second row of seats through the passage.

Generally, a space between the first row of seats and the second row of seats is limited, so that when a passenger attempts to go from a seat on one side of the second row of seats to a seat on the other side of the second row of seats, it may be inconvenient to pass through the space due to interference from the seat on the one side.

In addition, since a width of the passage between two seats of the second row of seats is generally limited, passengers may have difficulty passing through the passage.

The above information disclosed in this Background section is provided only to assist in more understanding of the background of the present disclosure, and may thus include information not included in the prior art already known to those skilled in the art to which the present disclosure pertains.

### SUMMARY

The present disclosure attempts to provide a seat adjustment apparatus of a vehicle and the vehicle including the same. By using the seat adjustment apparatus of the vehicle, passengers can conveniently pass within the vehicle.

According to an aspect of the present disclosure, there is provided a seat adjustment apparatus of a vehicle. The vehicle may include a first row of seats and a second row of seats positioned behind the first row of seats, the first row of seats may include a first seat and a second seat, and a passage for passenger traffic may be provided between the first seat and the second seat. The seat adjustment apparatus of the vehicle includes: a vehicle interior passenger sensor that detects a passenger on the first row of seats; and a vehicle exterior passenger sensor that detects a passenger outside the vehicle attempting to board the vehicle, in which, when it is determined that there is a passenger attempting to go to the second seat through a front of the first seat according to the detection results of the vehicle interior passenger sensor and the vehicle exterior passenger sensor, the first seat may be configured to move backward.

When it is determined that there is a passenger attempting to go to the second row of seats through the passage according to the detection results of the vehicle interior passenger sensor and the vehicle exterior passenger sensor, the first seat may be configured to move in a direction away from the second seat.

When it is determined that there is a passenger attempting to go to the second row of seats through the passage according to the detection results of the vehicle interior passenger sensor and the vehicle exterior passenger sensor, the first seat may be configured to move in a direction away from the second seat and backward.

When it is determined that there is a passenger attempting to go to the second row of seats through the passage according to the detection results of the vehicle interior passenger sensor and the vehicle exterior passenger sensor, the first seat may be configured to move in the direction away from the second seat and backward and the second seat may be configured to move in a direction away from the first seat.

When a predetermined time has elapsed since the first seat moved from an initial position, the first seat may be configured to return to the initial position.

The first seat may be positioned behind a passenger's seat and the second seat may be positioned behind a driver's seat, and when it is determined that there is no passenger inside the vehicle and only one passenger outside the vehicle attempting to board through a first seat-side door according to the detection results of the vehicle interior passenger sensor and the vehicle exterior passenger sensor, an angle of a backrest of the first seat may be configured to be adjusted within a predetermined range.

The first seat may be positioned behind a passenger's seat and the second seat may be positioned behind a driver's seat, and when it is determined that there is a passenger on the second seat and only one passenger outside the vehicle attempting to board through a first seat-side door according to the detection results of the vehicle interior passenger sensor and the vehicle exterior passenger sensor, an angle of a backrest of the first seat may be configured to be adjusted within a predetermined range.

The seat adjustment apparatus of the vehicle may further include a distance sensor that detects a distance between a head of a passenger on the first row of seats or the second row of seats and a vehicle ceiling, in which when it is determined that the distance between the head of the passenger and the vehicle ceiling is smaller than a first distance according to the detection result of the distance sensor, the seat on which the passenger is sitting may be configured to be lowered, when it is determined that the distance between the head of the passenger and the vehicle ceiling exceeds a second distance according to the detection result of the distance sensor, the seat on which the passenger is sitting may be configured to be raised, and the second distance may be greater than the first distance.

The vehicle interior passenger sensor may include a weight sensor mounted on the first row of seats, and include at least one selected from a camera, an infrared sensor, a laser radar, and an ultrasonic sensor mounted on an upper portion inside the vehicle, and the vehicle exterior passenger sensor may be mounted on the outside of the vehicle, and include at least one selected from a camera, an infrared sensor, a laser radar, and an ultrasonic sensor.

According to another aspect of the present disclosure, there is provided a vehicle including the seat adjustment apparatus of the vehicle according to the above aspect.

According to the seat adjustment apparatus of the vehicle and the vehicle of the present disclosure, passengers can conveniently board the vehicle and conveniently pass within the vehicle.

### BRIEF DESCRIPTION OF THE FIGURES

FIG. 1 is a diagram illustrating an interior of a conventional commercial vehicle.

FIG. 2 is a schematic diagram of an arrangement of seats of a vehicle according to an example embodiment.

FIG. 3 is a block diagram of a structure of a vehicle according to the embodiment of FIG. 2.

FIG. 4 is a block diagram of a structure of a seat adjustment apparatus according to the embodiment of FIG. 2.

FIG. 5 is a flowchart of seat adjustment according to the embodiment of FIG. 2.

FIG. 6 is a flowchart of seat adjustment according to another example embodiment.

FIG. 7 is a flowchart of seat adjustment according to another example.

### DETAILED DESCRIPTION

Hereinafter, exemplary embodiments of the present disclosure will be described. In addition, the following embodiments are merely illustrative, and the present disclosure is not limited to the following embodiments.

In addition, it should be understood that the drawings referenced above are not necessarily drawn to scale, and present rather simplified representations of various preferred features illustrating the basic principles of the present specification.

One or more methods described herein for one example embodiment may be combined with one or more methods of another example embodiment.

In this specification, the same reference numerals may be assigned to identical or similar structures, and redundant descriptions may be omitted. FIG. 2 is a schematic diagram of an arrangement of seats in a vehicle according to a first example embodiment. As illustrated in FIG. 2, a vehicle 100 according to the first embodiment includes three rows of seats. A first row of seats includes a seat A being a driver's seat and a seat B being a passenger's seat, and a second row of seats includes two seats, a seat C positioned at the rear or behind the driver's seat and a seat D positioned at the rear or behind the passenger's seat, respectively; a third row of seats is positioned at the rear of the second row of seats and includes three seats, that is, a seat E positioned at the rear or behind the seat C, a seat G positioned at the rear or behind the seat D, and a seat F positioned between the seat E and the seat G. A passage is provided between the seat C and the seat D, and a passenger may pass through to the third row of seats through the passage, and pass from the third row of seats to the second row of seats.

In addition, the vehicle 100 may include four doors, namely, a left front door outside the driver's seat, a right front door outside the passenger's seat, a left rear door outside the seat C, and a right rear door outside the seat D. The four doors are not illustrated in the drawings.

In the first embodiment, the seat D is configured to be able to move backward (leftward in FIG. 2) from an initial position by a driving unit, as indicated by a hollow arrow \textcircled{1}; to move backward while moving in a direction away from the seat C from the initial position, as indicated by a hollow arrow \textcircled{2}; and to move in the direction away from the seat C from the initial position (i.e., move outward, that is move downward in FIG. 2), as indicated by a hollow arrow \textcircled{3}. In addition, the seat D is configured to be able to adjust an angle of a backrest within a predetermined angle range by the driving unit. Here, the predetermined angle range is, for example, a range of 100° to 110°.

The seat C may have the same structure as the seat D. That is, the seat C is configured to be able to move backward (move to the left in FIG. 2) from an initial position by the driving unit; move backward while moving in a direction away from the seat D from the initial position; and move in the direction away from the seat D (i.e., move outward, that is move upward in FIG. 2) from the initial position. In addition, the seat C is configured to be able to adjust an angle of a backrest within a predetermined angle range by the driving unit.

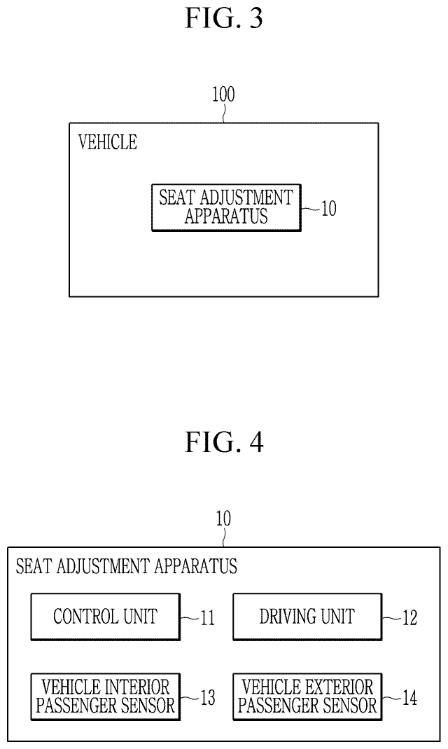

FIG. 3 is a block diagram of a structure of the vehicle 100 according to the first embodiment, and FIG. 4 is a block diagram of a structure of a seat adjustment apparatus 10 according to the first embodiment.

The vehicle 100 includes the seat adjustment apparatus 10. The seat adjustment apparatus 10 is for adjusting positions of the seat C and the seat D, and may move the seats C and D outward, backward, or outward and backward, respectively; and the seat adjustment apparatus 10 may adjust the angles of the backrests of the seats C and D, respectively.

The seat adjustment apparatus 10 includes a control unit 11, a driving unit 12, a vehicle interior passenger sensor 13 for detecting a passenger on the seats C and D, and a vehicle exterior passenger sensor 14 for detecting a passenger attempting to sit on the seats C to G from the outside of the vehicle.

The control unit 11 includes a central processing unit and a memory (storage medium). The memory may include a main memory device such as a random access memory (RAM), and an auxiliary memory device such as a flash memory.

The driving unit 12 includes an electric motor. By control of the control unit 11, the driving unit 12 may adjust the positions of the seats C and D so that the seats C and D move in a direction of one of the hollow arrows \textcircled{1}, \textcircled{2}, and \textcircled{3}, and may adjust the angles of the backrests of the seats C and D.

The vehicle interior passenger sensor 13 includes weight sensors mounted on the seats C and D, and at least one selected from a camera, an infrared sensor, a laser radar, and an ultrasonic sensor mounted on an upper portion of the vehicle 100. The weight sensors may determine presence or absence of passengers on the seats C and D by detecting load on the seats C and D. The camera, the infrared sensor, the laser radar, and the ultrasonic sensor may detect the presence or the absence of the passengers on the seats C and D and the number of passengers according to the related art.

The vehicle exterior passenger sensor 14 includes at least one of the following: a camera, an infrared sensor, a radar, and an ultrasonic sensor. The vehicle exterior passenger sensor 14 is mounted on the outside of the vehicle, and may be specifically mounted on an upper portion of the outside of the vehicle or mounted on a housing of a rearview mirror outside the seat B. The camera, the infrared sensor, the laser radar, and the ultrasonic sensor may detect the presence or the absence of passengers attempting to board outside the vehicle and the number of passengers according to the related art.

The seat adjustment apparatus 10 may detect the number of passengers on the seats C and D through the vehicle interior passenger sensor 13, and detect the number of passengers attempting to board outside the vehicle through the vehicle exterior passenger sensor 14.

In this embodiment, it is assumed that all passengers outside the vehicle are passengers attempting to sit on one of the seats C to G, and all of the passengers enter the vehicle through the door outside the seat D.

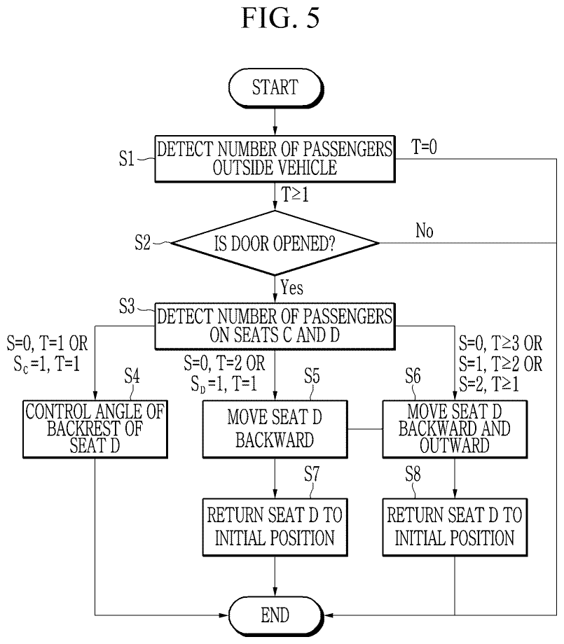

FIG. 5 is a flowchart of seat adjustment according to the first embodiment. Hereinafter, referring to FIG. 5, a method for adjusting a seat by the seat adjustment apparatus 10 is described.

First, when it is detected that the door of the vehicle 100 is unlocked or the driver starts the vehicle 100 (specifically, starts an engine or a motor of the vehicle 100), the seat adjustment method according to the first embodiment is started.

Then, at step S1, the vehicle external passenger sensor 14 detects whether there are passengers attempting to board outside the vehicle and the number of passengers attempting to board. Here, the number of passengers attempting to board is indicated by T. When there are no passengers attempting to board outside the vehicle (i.e., when the number T of the passengers attempting to board is 0), the method according to the present embodiment is terminated. When there are passengers attempting to board outside the vehicle (i.e., when the number T of the passengers attempting to board is 1 or more), the method proceeds to step S2.

In the step S2, it is detected whether the door outside the seat D (i.e., the right rear door of the vehicle 100) is opened. When it is detected that the door outside the seat D is not opened, the method according to the present embodiment is terminated. When it is detected that the door outside the seat D is opened, the method proceeds to step S3.

In the step S3, the number of passengers on the seats C and D is detected through the vehicle interior passenger sensor 13. When it is detected that there are no passengers on the seats C and D, the indoor passenger number S is set to 0. When it is detected that there are passengers on both the seats C and D, the indoor passenger number S is set to 2. When it is detected that there are passengers on the seat C and no passengers on the seat D, the indoor passenger number S is set to 1. When it is detected that there are passengers on the seat D and no passengers on the seat C, the indoor passenger number S is set to 1.

In order to distinguish between the indoor passenger number S when there is a passenger on the seat C and no passenger on the seat D and the indoor passenger number S when there is a passenger on the seat D and no passenger on the seat C, the indoor passenger number S when there is a passenger on the seat C and no passenger on the seat D is recorded as S_{C}, and the indoor passenger number S when there is a passenger on the seat D and no passenger on the seat C is recorded as S_{D}. In this case, S_{C} is 1 and S_{D} is also 1.

When the vehicle interior passenger sensor 13 detects that there is no passenger on the seats C and D (S=0) and the vehicle exterior passenger sensor 14 detects that there is 1 passenger (T=1) attempting to board outside the vehicle, the control unit 11 of the seat adjustment apparatus 10 determines that the passenger outside the vehicle is attempting to go to the seat D, and accordingly controls the driving unit 12 to adjust the angle of the backrest of the seat D. For example, the angle of the seat D may be increased within the range of 100° to 110° to allow passengers to sit more comfortably.

When the vehicle interior passenger sensor 13 detects that there is one passenger (S_{C}=1) on the seat C and the vehicle exterior passenger sensor 14 detects that there is one passenger (T=1) attempting to board outside the vehicle, the control unit 11 of the seat adjustment apparatus 10 determines that the passenger outside the vehicle is attempting to go to the seat D and accordingly controls the driving unit 12 to adjust the angle of the backrest of the seat D. For example, the angle of the seat D may be increased within the range of 100° and 110°.

That is, as illustrated in FIG. 5, when S=0 and T=1 or S_{C}=1 and T=1, the seat adjustment apparatus 10 advances to step S4 and adjusts the angle of the backrest of the seat D as described above.

When the vehicle interior passenger sensor 13 detects that there is no passenger (S=0) on the seats C and D and the vehicle exterior passenger sensor 14 detects that there are two passengers (T=2) attempting to board outside the vehicle, the control unit 11 of the seat adjustment apparatus 10 determines that the passengers outside the vehicle are attempting to go to the seats C and D, and increases the space between the seats D and B by moving the seat D backward by a first predetermined distance through the driving unit 12 in order to prevent the passengers from interfering with the seat D when going to the seat C. The first predetermined distance may be arbitrarily set in advance, and is, for example, 100 mm.

When the vehicle interior passenger sensor 13 detects that there is one passenger (S_{D}=1) on the seat D and the vehicle exterior passenger sensor 14 detects that there is one passenger (T=1) attempting to board outside the vehicle, the control unit 11 of the seat adjustment apparatus 10 determines that the passenger outside the vehicle is attempting to go to the seat C, and when the passenger goes to the seat C, the driving unit 12 causes the seat D to move backward by the first predetermined distance to increase the space between the seat D and the seat B in order to prevent the interference between the seat D and the passenger on the seat D.

That is, as illustrated in FIG. 5, when S=0 and T=2 or S_{D}=1 and T=1, the seat adjustment apparatus 10 advances to step S5 to cause the seat D to move backward by the first predetermined distance as described above.

After a predetermined time has elapsed, the process advances from the step S5 to step S7, and the control unit 11 of the seat adjustment apparatus 10 controls the driving unit 12 to return the seat D to the initial position. Here, the predetermined time may be arbitrarily set in advance, and is, for example, 30 seconds.

After the seat D returns to the initial position in the step S7, the method according to the present embodiment ends.

When the vehicle interior passenger sensor 13 detects that there is no passenger on the seats C and D (S=0) and the vehicle exterior passenger sensor 14 detects that there are three or more passengers attempting to board outside the vehicle (T≥3), the control unit 11 of the seat adjustment apparatus 10 determines that one passenger is attempting to go to the seat C and one passenger is attempting to go to the third row of seats through the passage between the seats C and D. Accordingly, the control unit 11 of the seat adjustment apparatus 10 causes the seat D to move in the direction (i.e., outward) away from the seat C and backward through the driving unit 12, thereby increasing the space between the seats C and B and the space of the passage between the seats C and D, thereby allowing the passengers to easily pass through the passages between the seats C and B and the seats C and D.

In this case, the seat D is set to move outward by a second predetermined distance, and the second predetermined distance may be arbitrarily set in advance, for example, 100 mm. In addition, the seat D is set to move backward by the first predetermined distance, and the first predetermined distance is, for example, 100 mm. Therefore, the seat D substantially moves approximately 140 mm in the direction of the arrow \textcircled{2} in FIG. 2.

When the vehicle interior passenger sensor 13 detects that there is one passenger (S=1) on the seat D and the vehicle exterior passenger sensor 14 detects that there are two or more passengers (T≥2) attempting to board outside the vehicle, the control unit 11 of the seat adjustment apparatus 10 determines that one passenger is attempting to go to a seat without passengers among the seats C and D and that one or more passengers are attempting to go to the third row of seats through the passage between the seats C and D. Accordingly, the control unit 11 of the seat adjustment apparatus 10 causes the seat D to move in the direction away from the seat C and to move backward through the driving unit 12, thereby increasing the space between the seats C and B and the space in the passage between the seats C and D, thereby allowing the passenger to easily pass through the seats C and B and the passage between the seats C and D.

When the vehicle interior passenger sensor 13 detects that there are passengers on both seats C and D (S=2) and the vehicle exterior passenger sensor 14 detects that there is at least one passenger attempting to board outside the vehicle (T≥1), the control unit 11 of the seat adjustment apparatus 10 determines that at least one passenger is attempting to go to the third row of seats through the passage between the seats C and D. Accordingly, the control unit 11 of the seat adjustment apparatus 10 causes the seat D to move in the direction away from the seat C and to move backward through the driving unit 12, thereby increasing the space between the seats C and B and the space in the passage between the seats C and D, thereby allowing the passenger to easily pass through the seats C and B and the passage between the seats C and D.

That is, as illustrated in FIG. 5, when S=0 and T≥3, or S=1 and T≥2, or S=2 and T≥1, the seat adjustment apparatus 10 advances to step S6 and the seat D moves outward by the second predetermined distance and moves backward by the first predetermined distance as described above. Here, in the condition of “S=1 and T≥2” in the step S6, “S=1” includes two cases of “S_{C}=1” and “S_{D}=1”.

After the predetermined time has elapsed, the method proceeds from the step S6 to step S8, and the control unit 11 of the seat adjustment apparatus 10 causes the seat D to return to the initial position via the driving unit 12. Here, the predetermined time may be arbitrarily set in advance, and is, for example, 30 seconds.

After the seat D returns to the initial position in the step S8, the method according to the present embodiment ends.

In the present embodiment, the first predetermined distance and the second predetermined distance are the same. However, the first predetermined distance and the second predetermined distance are not limited thereto, and the two may be different from each other and may be set arbitrarily.

In addition, the way in which the seat D moves outward and backward may not be the way indicated by the arrow \textcircled{2} in FIG. 2, but may first move backward by the first predetermined distance and then move outward by the second predetermined distance, or may first move outward by the second predetermined distance and then move backward by the first predetermined distance.

In the present embodiment, the seat D may be the first seat, and the seat C may be the second seat.

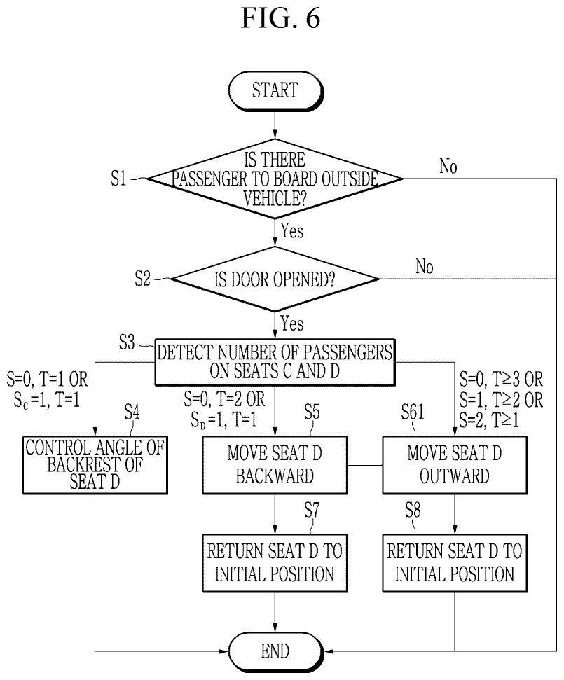

The seat adjustment apparatus 10 of the vehicle and the vehicle 100 according to the present embodiment allow the passenger to easily go to the seat C or the third row of seats through the seat D. FIG. 6 is a flowchart of seat adjustment according to a second embodiment. Hereinafter, the seat adjustment apparatus 10 of the vehicle and the vehicle 100 according to the second embodiment will be described with reference to FIG. 6. Hereinafter, only the differences between the second embodiment and the first embodiment will be described.

The step S6 of the flowchart of the first embodiment illustrated in FIG. 5 and step S61 of the flowchart of the second embodiment illustrated in FIG. 6 are different from each other.

In the step S6 of the first embodiment, when S=0 and T≥3, S=1 and T≥2, or S=2 and T≥1, the seat D moves outward (downward in FIG. 2) by the second predetermined distance and moves backward by the first predetermined distance.

In the step S61 of the second embodiment, when S=0 and T≥3, S=1 and T≥2, or S=2 and T≥1, the seat D does not move backward, but moves outward (downward in FIG. 2) by the second predetermined distance.

In other words, in the present embodiment, the seat D may move backward (e.g., the step S5) or outward (e.g., the step S61), and does not perform a complex movement in which it moves backward and outward (e.g., the step S6).

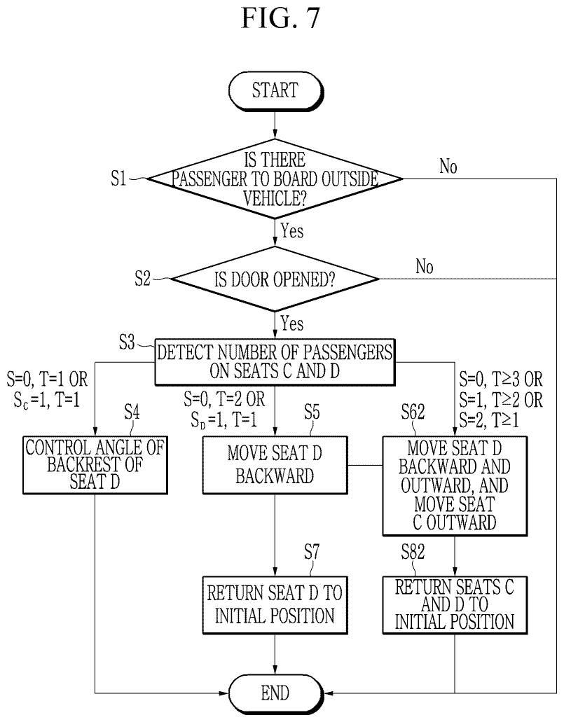

According to the embodiment, in addition to obtaining the same effect as the first embodiment, the structure related to the movement of the seat D is simple and the effect of not easily causing a breakdown may be obtained. FIG. 7 is a flowchart of seat adjustment according to a third embodiment. Hereinafter, the seat adjustment apparatus 10 of the vehicle and the vehicle 100 according to the third embodiment will be described with reference to FIG. 7. Hereinafter, only the differences between the third embodiment and the first embodiment will be described.

The steps S6 and S8 of the flowchart of the first embodiment illustrated in FIG. 5 and steps S62 and S82 of the flowchart of the third embodiment illustrated in FIG. 7 are different from each other.

In the step S6 of the first embodiment, when S=0 and T≥3, S=1 and T≥2, or S=2 and T≥1, the seat D moves outward (downward in FIG. 2) by the second predetermined distance and moves backward by the first predetermined distance. In the step S8, the seat D returns to the initial position. In the steps S6 and S8, the seat C does not move.

In the step S62 of a third embodiment, when S=0 and T≥3, S=1 and T≥2, or S=2 and T≥1, in addition to the seat D moving outward (downward in FIG. 2) by the second predetermined distance and moving backward by the first predetermined distance, the seat C moves in the direction (for example, outward, i.e. upward in FIG. 2) away from the seat D by a third predetermined distance. The third predetermined distance may be arbitrarily set in advance, for example, 100 mm.

In the step S82, in addition to the seat D returning to the initial position, the seat C returns to the initial position.

According to the present embodiment, in addition to obtaining the same effect as in the first embodiment, when a passenger attempts to go to the third row of seats through the passage between the seats C and D, the width of the passage between the seats C and D may be further increased, so that the passenger may board conveniently.

### Fourth Embodiment

Hereinafter, the seat adjustment apparatus 10 of the vehicle and the vehicle 100 according to the fourth embodiment will be described. Hereinafter, only the differences between the fourth embodiment and the first embodiment will be described.

In the first embodiment, the positions of the seats C to G may not be adjusted in a height direction. In the fourth embodiment, the seats C to G are configured to be able to adjust their positions in the height direction. Specifically, the control unit 11 of the seat adjustment apparatus 10 may control the driving unit 12, and the seats C to G may be raised and lowered in the height direction by the driving of the driving unit 12.

Typically, a vehicle seat supports a passenger at an appropriate height to maintain a good view of the passenger, and at the same time, keeps the passenger's head at a certain distance from the vehicle ceiling so that the passenger does not feel stuffy due to being too close to the vehicle ceiling. To this end, the seat adjustment apparatus 10 of the vehicle according to the present embodiment is configured to adjust the height of each seat C to G so as to maintain the distance between the passenger's head and the vehicle ceiling within a predetermined range of a first distance and a second distance. The first distance and the second distance may be arbitrarily set. In the present embodiment, the first distance is set to 50 mm, and the second distance is set to 150 mm.

A distance sensor is provided in the vehicle to detect the distance between the passenger's head of each seat C to G and the vehicle ceiling. In the present embodiment, the distance sensor includes at least one selected from a camera, an infrared sensor, a laser radar, and an ultrasonic sensor, and may be provided separately from the vehicle interior passenger sensor 13, or the vehicle interior passenger sensor 13 may also be used as the distance sensor according to the present embodiment.

When the distance between the passenger's head and the vehicle ceiling is determined to be less than the first distance (i.e., 50 mm) based on the detection result of the distance sensor, the control unit 11 of the seat adjustment apparatus 10 lowers the seat on which the passenger is sitting through the drive unit 12. For example, the control unit 11 ensures that the distance between the passenger's head and the vehicle ceiling after the seat is lowered is within the above-described predetermined range.

When the distance between the passenger's head and the vehicle ceiling is determined to exceed the second distance (i.e., 150 mm) based on the detection result of the distance sensor, the control unit 11 of the seat adjustment apparatus 10 raises the seat on which the passenger is sitting through the drive unit 12. For example, the control unit 11 ensures that the distance between the passenger's head and the vehicle ceiling after the seat is raised is within the above-described predetermined range.

According to the present embodiment, in addition to obtaining the same effect as the first embodiment, the passenger's field of view may be maintained well, and at the same time, the passenger may be prevented from feeling stuffy due to being too close to the vehicle ceiling.

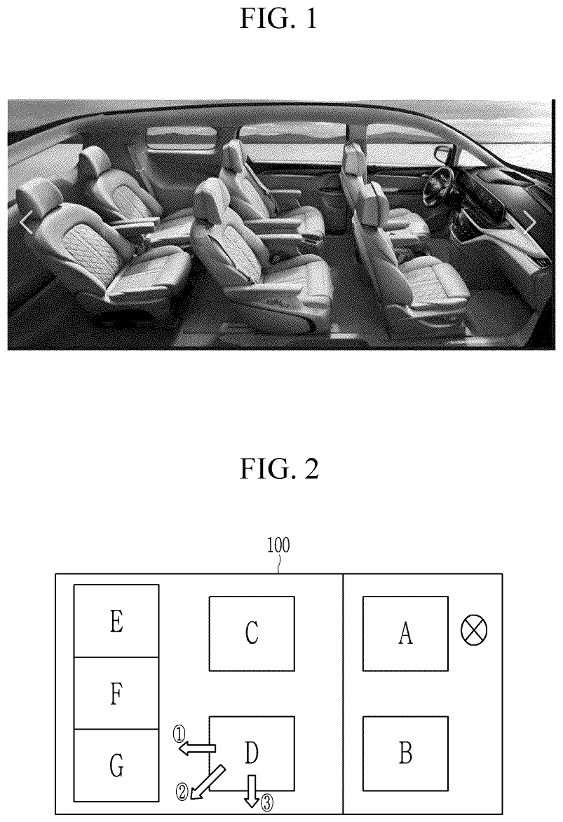

In this specification, the present disclosure has been described that the vehicle in which the third row of seats has three seats as an example, but is not limited thereto. The third row of seats of the vehicle may also have two seats, as illustrated in FIG. 1. In addition, according to an embodiment of the present disclosure, the vehicle is not limited to a commercial vehicle or a private vehicle, and may be any type of vehicle having the seat adjustment apparatus of the vehicle according to an embodiment of the present disclosure.

In this specification, the present disclosure has been described using the vehicle having a driver's seat and a passenger's seat (seat A and seat B) as an example, but is not limited thereto. According to an embodiment of the present disclosure, the vehicle may be an autonomous vehicle without the driver's seat and the passenger's seat.

In this specification, the exemplary embodiment of the present disclosure has been described using a vehicle having three rows of seats as an example, but is not limited thereto. According to an exemplary embodiment of the present disclosure, the vehicle may have four or more rows of seats.

In this specification, the exemplary embodiment of the present disclosure has been described using the vehicle having the driver's seat positioned at the left front inside the vehicle and the passenger's seat positioned at the right front inside the vehicle, but is not limited thereto. According to an exemplary embodiment of the present disclosure, the vehicle may have the driver's seat positioned at the right front inside the vehicle and the passenger's seat positioned at the left front inside the vehicle.

In this specification, the terms “first” and “second” are only for the purpose of explanation and should not be understood as specifying or implying the relative importance or order of technical features.

While the present disclosure has been described in connection with what is presently considered to be practical embodiments, it is to be understood that the present disclosure is not limited to the disclosed embodiments. On the contrary, it is intended to cover various modifications and equivalent arrangements included within the spirit and scope of the appended claims.

1. A seat adjustment apparatus of a vehicle, wherein the vehicle comprises a first row of seats and a second row of seats positioned behind the first row of seats, the first row of seats including a first seat and a second seat and a passage provided between the first seat and the second seat,
the seat adjustment apparatus comprising:
a vehicle interior passenger sensor that detects a passenger on the first row of seats; and
a vehicle exterior passenger sensor that detects a passenger outside the vehicle attempting to board the vehicle,
wherein, when it is determined that there is a passenger attempting to move to the second seat through a front of the first seat according to the detection results of the vehicle interior passenger sensor and the vehicle exterior passenger sensor, the first seat is configured to responsively move backward.

2. The seat adjustment apparatus of the vehicle of claim 1, wherein:
when it is determined that there is a passenger attempting to move to the second row of seats through the passage according to the detection results of the vehicle interior passenger sensor and the vehicle exterior passenger sensor, the first seat is configured to responsively move in a direction away from the second seat.

3. The seat adjustment apparatus of the vehicle of claim 1, wherein:
when it is determined that there is a passenger attempting to move to the second row of seats through the passage according to the detection results of the vehicle interior passenger sensor and the vehicle exterior passenger sensor, the first seat is configured to responsively move in a direction away from the second seat and backward.

4. The seat adjustment apparatus of the vehicle of claim 3, wherein:
when it is determined that there is a passenger attempting to move to the second row of seats through the passage according to the detection results of the vehicle interior passenger sensor and the vehicle exterior passenger sensor, the first seat is configured to move responsively in the direction away from the second seat and backward and the second seat is configured to move responsively in a direction away from the first seat.

5. The seat adjustment apparatus of the vehicle of claim 1, wherein:
when a predetermined time has elapsed since the first seat moved from an initial position, the first seat is configured to return to the initial position.

6. The seat adjustment apparatus of the vehicle of claim 1, wherein:
the first seat is positioned behind a passenger's seat and the second seat is positioned behind a driver's seat, and
when it is determined that there is no passenger inside the vehicle and only one passenger outside the vehicle attempting to board through a first seat-side door according to the detection results of the vehicle interior passenger sensor and the vehicle exterior passenger sensor, an angle of a backrest of the first seat is configured to be adjusted within a predetermined range.

7. The seat adjustment apparatus of the vehicle of claim 1, wherein:
the first seat is positioned behind a passenger's seat and the second seat is positioned behind a driver's seat, and
when it is determined that there is a passenger on the second seat and only one passenger outside the vehicle attempting to board through a first seat-side door according to the detection results of the vehicle interior passenger sensor and the vehicle exterior passenger sensor, an angle of a backrest of the first seat is configured to be adjusted within a predetermined range.

8. The seat adjustment apparatus of the vehicle of claim 1, further comprising:
a distance sensor that detects a distance between a head of a passenger on the first row of seats or the second row of seats and a vehicle ceiling,
wherein when it is determined that the distance between the head of the passenger and the vehicle ceiling is smaller than a first distance according to the detection result of the distance sensor, the seat on which the passenger is sitting is configured to be responsively lowered,
when it is determined that the distance between the head of the passenger and the vehicle ceiling exceeds a second distance according to the detection result of the distance sensor, the seat on which the passenger is sitting is configured to be responsively raised, and
the second distance is greater than the first distance.

9. The seat adjustment apparatus of the vehicle of claim 1, wherein:
the vehicle interior passenger sensor includes a weight sensor mounted on the first row of seats, and at least one selected from a camera, an infrared sensor, a laser radar, and an ultrasonic sensor mounted on an upper portion inside the vehicle, and
the vehicle exterior passenger sensor is mounted on the outside of the vehicle, and includes at least one selected from a camera, an infrared sensor, a laser radar, and an ultrasonic sensor.

10. A vehicle including the seat adjustment apparatus of the vehicle of claim 1.

11. A method for seat adjustment of a vehicle comprising:
wherein the vehicle comprises a first row of seats and a second row of seats positioned behind the first row of seats, the first row of seats including a first seat and a second seat and a passage provided between the first seat and the second seat,
detecting, via a vehicle interior passenger sensor, a passenger on the first row of seats; and
detecting, via a vehicle exterior passenger sensor, a passenger outside the vehicle attempting to board the vehicle,
in response to a determination that there is a passenger attempting to move to the second seat through a front of the first seat, sending instructions to move the seat backward.

12. The method of claim 11, further comprising the step of:
sending instructions to move the first seat to return to an initial position when a predetermined time has elapsed since the first seat moved from the initial position.

13. The method of claim 11, further comprising:
Sending instructions to responsively move the first seat in a direction away from the second seat when it is determined that there is a passenger attempting to move to the second row of seats through the passage according to the detection results of the vehicle interior passenger sensor and the vehicle exterior passenger sensor.

14. A non-transitory computer readable medium storing instructions that, when executed by a system, cause the system to perform the method of claim 11.
